(19) United States
(12) Patent Application Publication
(10) Pub. No.: US 2011/0276737 A1
(43) Pub. Date: Nov. 10, 2011

(54) METHOD AND SYSTEM FOR REORDERING THE REQUEST QUEUE OF A HARDWARE ACCELERATOR

(75) Inventors: Xiaolu Mei, (US); Dong Xie, Shanghai (CH); Jun Zheng, Beijing (CH); Xiaotao Chang, Beijing (CH); Kuan Feng, Shanghai (CH)

(73) Assignee: INTERNATIONAL BUSINESS MACHINES CORPORATION, Armonk, NY (US)

(21) Appl. No.: 13/091,511

(22) Filed: Apr. 21, 2011

(30) Foreign Application Priority Data
May 10, 2010 (CH) 201010188583.7
May 31, 2010 (CN) 201010188583.7

(51) Int. Cl. G06F 13/12

(52) U.S. Cl. 710/112

(57) ABSTRACT

The invention discloses a system and method for reordering the request queue of the hardware accelerator, wherein, the request queue stores therein a plurality of coprocessor request blocks (CRBs) to be input into the hardware accelerator. The system including: content addressable memory connected to the request queue for storing the state pointer of each CRB in the request queue at a same physical storage location in the request queue, receiving the state pointer of a new CRB in response to the new CRB asking to join in the request queue and outputting the physical storage location of a CRB in the request queue whose state pointer stored in the content addressable memory is the same as the state pointer of the new CRB; and CRB insertion module for receiving the physical storage location of a CRB in the request queue whose state pointer is the same as the state pointer of the new CRB and inputting the new CRB in the request queue and the CRB in the request queue whose state pointer is the same as the state pointer of the new CRB adjacently into the hardware accelerator in the order of entering the request queue. The system and method can improve the process efficiency of the hardware accelerator.

### RELATED APPLICATION

This Application is based on and claims the benefit of Priority from China Patent Application 201010188583.7, filed May 31, 2010.

### TECHNICAL FIELD OF THE INVENTION

The invention generally relates to signal processing, more particularly, to a method and system for reordering the request queue of a hardware accelerator.

### BACKGROUND OF THE INVENTION

Constitution of CMP (chip multiprocessors) is divided into two types: homogeneous and heterogeneous, in which homogeneous refers to that structure of internal cores that are the same and heterogeneous refers to that structure of internal cores that are different.

FIG. 1 shows a modular structure of a heterogeneous multi-core processor chip 100. In FIG. 1, the CPU is a general purpose processor, Ethernet Media Access Controller (EMAC) including EMAC0, EMAC1, EMAC2 (all of which are network accelerating processors), together with a hardware accelerator arc dedicated processors. A hardware accelerator is widely used in multi-core processors, especially for computing intensive applications such as communication, financial service, energy resource, manufacturing, chemistry and the like. Currently, a hardware accelerator integrated in some multi-core processor chip primarily includes compressing/decompressing the accelerator, encoding/decoding the accelerator, mode recognizing the accelerator, XML parsing the accelerator and the like. The memory controller in FIG. 1 is used to control the cooperative working between the chip and memory and the request queue is used to store requests that have been received but not yet processed by the accelerator.

Next, taking application of filtering compression requests in telecommunication data for example, the data flow in the chip shown in FIG. 1, as well as how each module cooperates, will be described. Those skilled in the art will recognize that in other applications where messages need to be quickly processed, such as in financial services, energy resources, manufacturing, chemistry and the like, the problem is similar. In an application of filtering compression requests in telecommunication data, one or more telecommunication servers are used to process received and compressed packets and, after being decompressed, the packets are sent out when it is confirmed that the packets do not contain sensitive information. In particular, the EMAC module of multi-core processor chips in the server receives a plurality of packets to be decompressed; for example, the packets may be Http 1.1 packets supporting encoding, the CPU (computer processing unit) re-encapsulates them as coprocessor request blocks (CRB) after information related to network protocol of each packet is removed. CRB itself is not a packet but includes information such as the relevant location of specified data, etc. CRB is placed in the request queue and asks the hardware accelerator to decompress data specified by the CRB. After the hardware accelerator receives the request, it decompresses the data block specified by the CRB and returns the decompressed result to the CPU, such that the CPU can decide whether the data block contains sensitive information. If not, the data block can be forwarded; otherwise, the data block will be directly dropped. Thus, the data block received at the receiver side is incomplete and the receiver side itself needs all the data blocks to perform the decompression to acquire the data to be sent; therefore, the receiver side cannot send data, which means the sensitive information cannot be transmitted through the telecommunication network.

The application of filtering compression requests in telecommunication data will receive huge amounts of message sending requests; therefore, the processing speed for messages has to be very fast. Generally, processing speeds of software can hardly satisfy real-time requirements of telecommunication applications. In telecommunications, the hardware accelerator on multi-core processor chips, shown in FIG. 1, will typically be employed to accomplish decompression. However, for such applications, when the hardware accelerator decompresses the compressed data specified by the next CRB, it needs the state of the data specified by the previous CRB, such as the data decompression results specified by the previous CRB, etc. Therefore, except for the state of the last CRB of a message, the state of other CRBs of the message and data specified by all CRBs needs to be stored in memory.

As such, when hardware accelerator processes CRB of the request queue, it not only needs to acquire data specified by the CRB from memory, but also needs to store the state of the data specified by the CRB in memory repeatedly, and acquire the state of the stored data specified by the CRB, thereby slowing the process speed of the whole chip and lowering efficiency.

### SUMMARY OF THE INVENTION

The hardware accelerator in the art needs to frequently access memory, the access memory time is very long when compared to the process time of the CPU, such that the process efficiency of the whole chip and, therefore, the server system, is very low and more energy resources are consumed. Therefore, what is needed is a method and system capable of improving process efficiency for the above-described hardware accelerator.

According to an aspect of the invention, there is provided a system for reordering the request queue of the hardware accelerator, wherein the request queue stores therein a plurality of CRBs to be input into the hardware accelerator, the system includes: content addressable memory connected to the request queue for storing the state pointer of each CRB in the request queue at a same physical storage location in the request queue; receiving the state pointer of a new CRB in response to the new CRB asking to join in the request queue; outputting the physical storage location of a CRB in the request queue whose state pointer is stored in the content addressable memory and is the same as the state pointer of the new CRB; and the CRB insertion module for receiving the physical storage location of a CRB in the request queue whose state pointer is the same as the state pointer of the new CRB and inputting the new CRB in the request queue and the CRB in the request queue whose state pointer is the same as the state pointer of the new CRB adjacently into the hardware accelerator in the order of entering the request queue.

According to another aspect of the invention, there is provided a method for reordering the request queue of the hardware accelerator, wherein the request queue stores therein a plurality of CRBs to be input into the hardware accelerator, the method including:

receiving the state pointer of a new CRB in response to the new CRB asking to join in the request queue;

acquiring the physical storage location of a CRB in the request queue whose state pointer is stored in the request queue is the same as the state pointer of the new CRB; and

inputting the new CRB in the request queue and the CRB in the request queue whose state pointer is the same as the state pointer of the new CRB adjacently into the hardware accelerator in the order of entering the request queue.

According to yet another aspect of the invention, there is provided a chip including the system for reordering the request queue of the hardware accelerator as described above.

### BRIEF DESCRIPTION OF THE DRAWINGS

The above and other objects, features and advantages of the invention will become more apparent from the more detailed description of exemplary embodiments of the invention in the accompany drawings; wherein the same or similar reference number in the accompanying drawings generally represents the same or similar elements in the exemplary embodiments of the invention.

FIG. 1 shows the modular structure of a heterogeneous multi-core processor chip 100;

FIG. 2 illustratively shows the structure of the present CRB;

FIG. 3 shows the arrangement of the CRBs in the request queue taking the received three (3) messages in the request queue, for example;

FIG. 4 illustratively shows the CRB distribution of the above three (3) messages;

FIG. 5a shows the state of the CRB of the respective messages in the request queue and the procedure of interacting with the memory for storing and retrieving the state information during processing;

FIG. 5b shows the logic ordering sequence of the CRB in the request queue of FIG. 5a according to the method and system of the invention and procedure of interacting with memory for storing and retrieving the state information during processing;

FIG. 6 illustratively shows a structural diagram of a system for reordering the request queue of the hardware accelerator according to one embodiment of the invention;

FIG. 7 shows a structural diagram of an extended CRB;

FIG. 8 shows the structure of the CRB insertion module;

FIG. 9 shows the change of the CRB in the request queue using the technical solution of the FIG. 8;

FIG. 10 shows another structure of the CRB insertion module;

FIG. 11 shows a structural diagram of a system for reordering the request queue of the hardware accelerator according to another embodiment of the invention;

FIG. 12 shows a flowchart of a method for reordering the request queue of the hardware accelerator according to one embodiment of the invention;

FIG. 13 shows a preferred embodiment of the method shown in FIG. 12;

FIG. 14 shows another preferred embodiment of the method shown in FIG. 12; and

FIG. 15 shows still another preferred embodiment of the method shown in FIG. 12.

### DETAILED DESCRIPTION OF THE PREFERRED EMBODIMENTS

Preferred embodiments of the invention will be described in detail with reference to the drawings in which the preferred embodiments are shown. However, the invention can be realized in various forms and should not be construed as limited to the embodiments described herein. Rather, these embodiments are provided to enable the invention to be more apparent and complete and fully convey the scope of the invention to those skilled in the art.

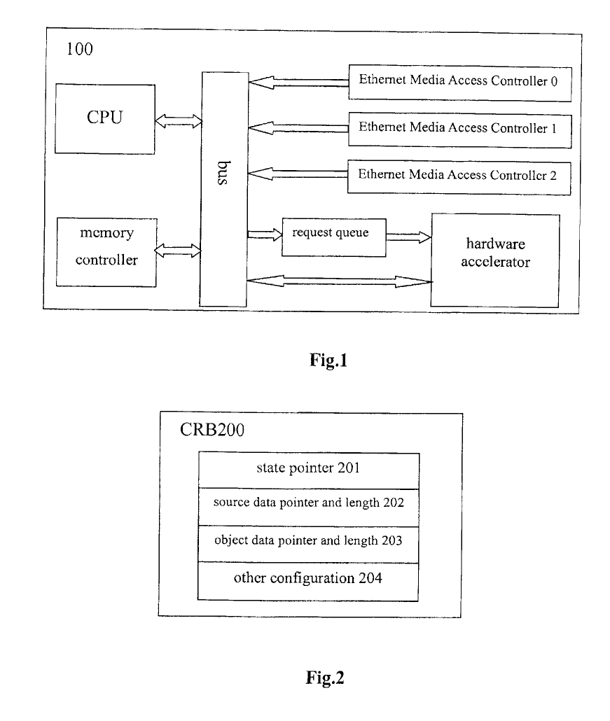

After information relevant to the network protocol of the received packet is removed by the CPU, data information is stored in memory and information relevant to the storage location of the data information in memory is encapsulated as a CRB. Said information is then sent to the request queue for processing by the hardware accelerator. FIG. 2 illustratively shows the structure of the present CRB. CRB 200 contains state pointer 201, source data pointer and length 202, object data pointer and length 203 and other configurations 204. State pointer 201 is a pointer to the initial location of the reserved state stored in memory after the data specified by the current CRB is processed so that the state information may be acquired and used according to the initial location when data specified by the next CRB is processed. A message may contain a plurality of CRBs, but a message only needs to reserve the storage location of one piece of the state information in memory. Because current CRB can be processed as long as the state of the previous CRB is reserved, the next CRB can be processed when the state of the current CRB is still reserved in the storage location of the state information and the state of the previous CRB is no longer needed. Preferably, state pointer 201 can also include the length of the state information, because the length of some state information may be variable. For example, if the hardware accelerator is to decompress the CRB, the state information may include the storage location of the data decompressed from the previous CRB, the length of the data decompressed from the previous CRB, etc. For encoding/decoding the application, if the encoding key of the specified data used by each CRB is different, the state information is the encoding key of the data specified by the CRB, etc. The source data pointer and length 202 is a pointer to the storage location of the original data specified by the CRB in the memory and length of the original data specified by the CRB; object data pointer and length 203 is a pointer to the storage location of the processed data specified by the CRB in the memory and length of the processed data specified by the CRB; other configurations 204 are configurable according to the requirements of the application. Data specified by each CRB, including source data (such as compressed data) and object data (such as decompressed data), may be placed in the memory according to the memory location specified by the CRB, i.e. data pointer.

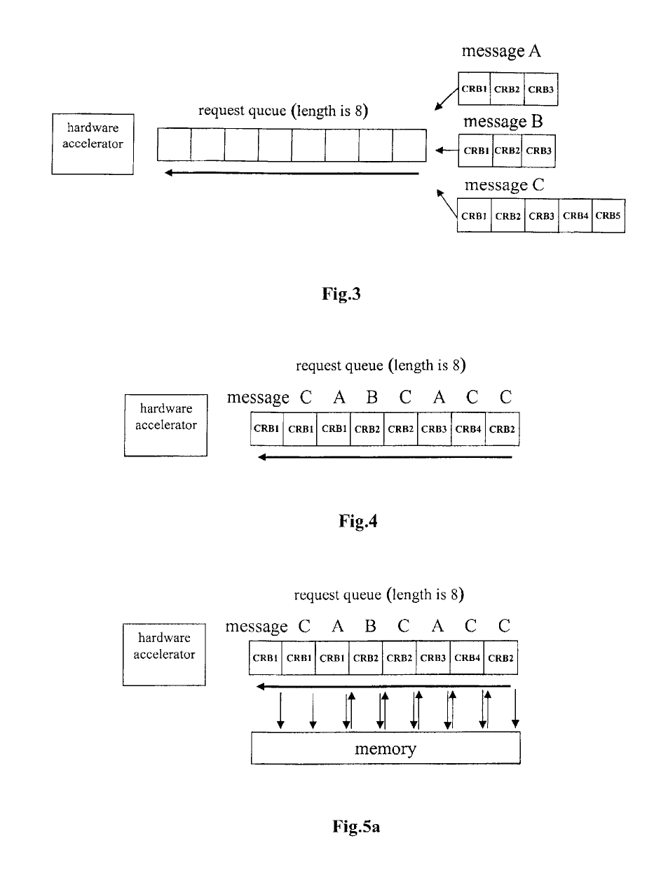

FIG. 3 shows the arrangement of the CRBs in the request queue taking the three (3) messages received in the request queue for an example, the three (3) messages are message A (including three (3) CRBs), message B (including three (3) CRBs) and message C (including five (5) CRBs), respectively. In this example, assume the length of the request queue is eight (8) CRBs.

Distribution of the CRBs of the respective messages in the request queue is decided by the ordering of packets received at the CPU. FIG. 4 illustratively shows the CRB distribution of the above three (3) messages. In prior art, hardware accelerator decompresses data specified by each CRB sequentially according to the order of CRBs in the request queue as shown in FIG. 4.

Taking the decompression application for example, since the state information of the relevant CRB is needed during decompression, for example, the first CRB of message A may be directly decompressed; for the second CRB of message A, part of the information of the first CRB is needed during decompression; and for the third CRB of message A, part of the information of the second CRB is needed during decompression, etc. Thus, the hardware accelerator cannot decompress all the CRBs in case the request queue in FIG. 1 only contains the respective CRB. In actual design, the relevant CRB state is stored in memory and is retrieved from memory as needed. Further, when the CRBs of the respective messages enter into a telecommunications server, the CPU of the multi-core processors of the server may have control. For each message, its CRB enters into the data queue according to a time sequence. That is, the first CRB of message A arrives earlier than the second CRB of message A, the second CRB of message A arrives earlier than the third CRB of message A, etc. However, there is no logical order among the CRBs of the respective messages.

FIG. 5a shows the state of the CRB of the respective message in the request queue and the procedure of interacting with the memory for storing and retrieving the state information during processing. According to FIG. 5a, when the first CRB of message C is decompressed, the hardware accelerator needs to store the state of the CRB in memory (writing in memory);. When the first CRB of message A arrives, the hardware accelerator also needs to store the state of the CRB in memory (writing in memory). When the first CRB of message B arrives, the hardware accelerator also needs to store the state of the CRB in memory (writing in memory). Then, when the second CRB of message C arrives, the hardware accelerator first needs to acquire the stored state of the first CRB of message C in memory (read from memory), then can it decompress the second CRB of current message C, then it writes the state of the CRB into memory, and so on, the arrow downwards represents an operation of the writing state into memory, the arrow upwards represents an operation of the reading state from memory. It can be seen that frequent access of memory is required. The time to access memory is very long as compared to the process time of the CPU, such that the process efficiency of the whole chip and, therefore, the server system, is very low and more energy resources are consumed.

The invention provides a method and system for reordering the request queue of the hardware accelerator. The method and system can reduce the hardware accelerator's read and write operation to memory due to the necessity of storing the state of the CRB for processing the data specified by the CRB and acquiring the state of the data specified by the relevant CRB, by making the hardware accelerator process the respective CRBs of a same message in an adjacent manner. FIG. 5b shows a logical ordering sequence of the CRB in the request queue of FIG. 5a according to the method and system of the invention and the procedure of interacting with memory for storing and retrieving the state information during processing. For example, for CRB1, CRB2 and CRB3 of message C, the hardware accelerator may determine that the state of the current CRB may be directly used to process the next CRB. Thus, the state thereof does not need to be stored in memory. Likewise, when processing CRB2, CRB3 and CRB4, the state of the relevant CRB does not need to be retrieved from memory. The state of memory is needed only after CRB4 is processed. Obviously, as compared to the state information interacting procedure of FIG. 5, the procedure of interacting with memory about the state is significantly reduced. However, although these states do not need to be stored in memory, they still need to be reserved during processing so that the hardware accelerator can perform the subsequent processing. Moreover, when the hardware accelerator processes the CRB, it needs to acquire the data specified by the CRB from memory. The procedure of interacting with memory cannot be reduced.

The invention will use content addressable memory (CAM). CAM is memory that is addressable by content and is a special storage array random access memory (RAM), its main operating mechanism is to compare an input data entry with all data entries stored in CAM automatically and simultaneously, and decide whether this input data entry matches with data entry stored in CAM. If there is a data entry that matches, the address information of that data entry is output. CAM is a hardware module with wiring from the respective data entry to CAM (digital data entry). For example, when data entry is 64 bits, if a data entry is input and seven (7) data entries are stored in CAM, then wirings to CAM are 8×64, resulting in a relatively large area. During the procedure of integrated circuit design, design tools will provide the CAM modules. A design tool can provide the required CAM modules as long as the digital number of data entries and the number of data entries are input.

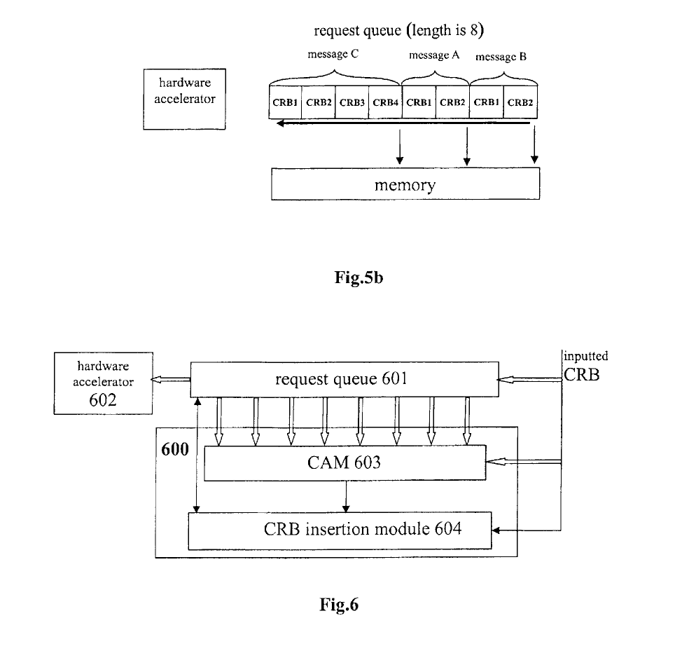

FIG. 6 illustratively shows a structural diagram of a system 600 for reordering the request queue of the hardware accelerator according to one embodiment of the invention. Wherein, the request queue 601 stores therein a plurality of CRBs to be input into the hardware accelerator 602. As shown in FIG. 6, the system 600 includes: CAM 603 and CRB insertion module 604. Wherein CAM 603 is connected to request queue 601 to store the state pointer of each CRB in the request queue 601 at a same physical storage location in the request queue 601, receives the state pointer of a new CRB in response to the new CRB asking to join in the request queue and outputs the physical storage location of the CRB in the request queue whose state pointer is stored in the content addressable memory and is the same as the state pointer of the new CRB to the CRB insertion module 604. CRB insertion module 604 receives the physical storage location of a CRB in the request queue whose state pointer is the same as the state pointer of the new CRB and inputs the new CRB in the request queue and is the CRB in the request queue whose state pointer is the same as the state pointer of the new CRB adjacently located in the hardware accelerator in the order of entering the request queue. Obviously, if there is no CRB whose state pointer is stored in CAM and is the same as the state pointer of the new CRB, then the CRB insertion module 604 may directly insert the new CRB into the end of request queue.

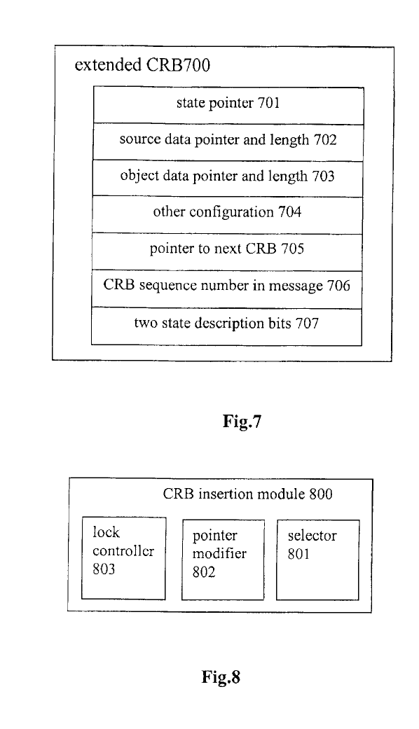

In one embodiment, the CRB structure of FIG. 2 needs to be further extended such that each CRB contains a pointer item for pointing to the location of the next CRB in the request queue that is to be input into the hardware accelerator. Each CRB further contains the CRB sequence number in the message for specifying the sequence of the CRB in all CRBs describing that message. For example, the sequence number of the first CRB in message A may be Al and so on. Still further, in order for the hardware accelerator to process the CRB more easily, each CRB further contains two (2) state description bits in which one state description bit is used to indicate whether the state of the current CRB is “to store”. For example, if the state bit is 1, it represents that the state following the CRB process should be stored in memory. If the state bit is 0, it represents that the state following the CRB process does not need to be stored in memory. Bits 0 and 1 are both illustrative and those skilled in the art can choose suitable bits or data to represent whether the state of the CRB is to be stored in memory. The other state description bit is used to indicate whether the state of the current CRB is “to retrieve”. For example, if the state bit is 1, it represents that the state of the current CRB stored in memory should be retrieved first when processing the CRB. If the state bit is 0, it represents that there is no need to first retrieve the state of the current CRB stored in memory when processing the CRB. Bits 0 and 1 are both illustrative and those skilled in the art can choose suitable bits or data as needed to indicate whether the current state of the message previously stored in memory needs to be retrieved when processing the CRB. These two (2) state description bits are preferable. Each can facilitate the processing of the hardware accelerator. However, if the CRB does not contain the two (2) state description bits and the hardware accelerator contains additional processes to achieve the same aim. FIG. 7 shows a structural diagram of an extended CRB that further contains the pointer to the next CRB in the request queue 705. The CRB sequence number in message 706, preferably, further contains two (2) state description bits 707. Those skilled in the art can appreciate that FIG. 7 is illustrative. The pointer to the next CRB in request queue 705, the CRB sequence number in message 706 and the two (2) state description bits 707 may also be included in other configurations 704 as sub-items. As such, the location of the CRB in the request queue contains two (2) kinds of locations, one is a real physical location that is consistent with the order of the CRB entering into the request queue; the other is the logical location that is specified by the pointer item of 705 and is consistent with the order of CRB entering into the hardware accelerator.

In the above embodiment, the CRB insertion module controls the new CRB in the request queue 601 and a CRB whose state pointer is the same as the state pointer of the new CRB so that they are adjacently input into the hardware accelerator 602 in the order they entered the request queue 601 by modifying the pointer location of the CRB in the request queue. In particular, FIG. 8 shows the module structure of the CRB insertion module that includes selector 801 for receiving the physical storage location of the CRB in the request queue whose state pointer is the same as the state pointer of the new CRB and selecting the CRB corresponding to the physical storage location having the largest CRB sequence number in the message as the CRB to be processed in case there are a plurality of physical storage locations. For example, if CRB1, CRB2, CRB3 and CRB4 of message C are included, i.e. the sequence numbers are 1, 2, 3 and 4, then CRB4 is selected as the CRB to be processed; pointer modifier 802 for modifying the request queue pointer item of the new CRB pointing to a next CRB as the original pointer item of the CRB to be processed pointing to a next CRB and modifying the original pointer item of the CRB to be processed pointing to a next CRB as the pointer item pointing to the new CRB according to the physical storage location of the CRB to be processed as determined by the selector. As such, modification of the logical location of the CRB in the request queue is accomplished. The new CRB in the request queue 601 and the CRB in the request queue whose state pointer is the same as the state pointer of the new CRB are input adjacently into the hardware accelerator 602 in the order they entered the request queue 601. Preferably, the pointer modifier 802 also updates the state of the two (2) state description bits 707 accordingly, such that the hardware accelerator knows how to process the state while processing the CRB. Selector 801 and pointer modifier 802 may be implemented with hardware logic. The design tool can automatically generate the logic after the function thereof is described by the hardware description language.

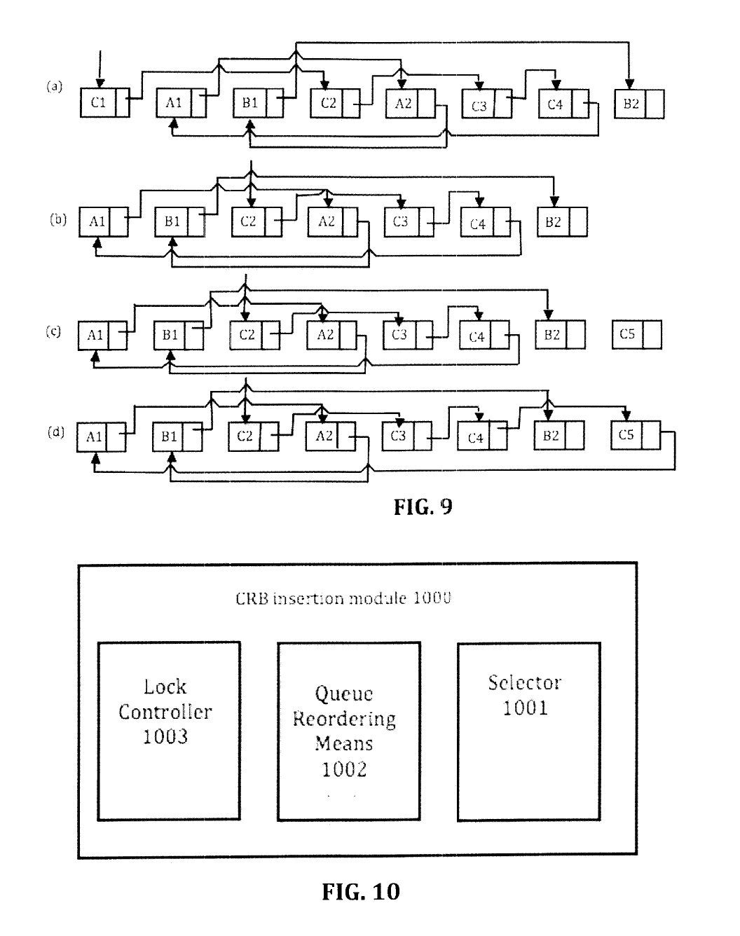

FIG. 9 shows the change of the CRB in the request queue using the technical solution of the FIG. 8, assuming that the request queue contains eight (8) CRBs. The arrow downwards in the figure represents that the CRB is the next CRB to be input into the hardware accelerator. In FIG. 9, (a) represents that the request queue is full and that the new CRB cannot be joined. However, after the logical first CRB, i.e. first CRB of message C (C1), enters into the hardware accelerator, the location of one CRB in the request queue is emptied, as shown in (b). At this time, the new CRB may be accepted; (c) shows that a new CRB (C5) asks to join in the request queue. It is decided by CAM that the state pointers of C2, C3 and C4 in the request queue are the same as that of C5. The locations of these three (3) CRBs in the request queue are returned to the comparator. The comparator determines that C4 is the CRB to be processed. In (d), the pointer item of the next CRB of C5 is pointed to A1. The pointer item of the next CRB of C4 is modified from pointing to A1 to pointing to C5. As such, the respective CRBs of message C will enter into the hardware accelerator in the order of C1->C2->C3->C4->C5, thereby reducing the procedure of interacting with memory for storing and retrieving the state of the CRB.

In one preferred embodiment, the CRB insertion module 800 further includes lock controller 803 for controlling the input of the CRB from the request queue to the hardware accelerator. Lock controller 803 locks input of the CRB from the request queue to the hardware accelerator in response to a new CRB asking to join the request queue and removes the above lock in response to a new CRB having joined in the request queue. Since the speed of processing the CRB by the hardware accelerator is much slower than the processing speed of the CRB insertion module, generally it won't be a big problem if there is no lock controller. The lock controller is a preferred module. The hardware accelerator can acquire the next CRB to be processed only when the lock controller removes the lock. Lock controller 803 may be implemented with hardware logic and the design tool can automatically generate the logic after the function thereof is described by the hardware description language.

In another embodiment, the CRB structure of FIG. 2 needs to be changed, as shown in FIG. 7. However, the pointer to the next CRB 705 is not included. Other changes are included, that is, the CRB further includes the CRB sequence number in the message for indicating the CRB sequence of the CRB in all the CRB messages describing the message. Preferably, the CRB also contains the two (2) state description bits, in which one state description bit is used to indicate whether the state of the processed CRB is stored in memory, and the other state description bit is used to indicate whether processing of the CRB needs to retrieve the current state of the message previously stored in memory. In the present embodiment, the physical location of each CRB in the request queue changes location as shown in FIG. 6). At this time, the logical location and the physical location of the CRB in the request queue are the same. FIG. 10 shows another structure of CRB insertion module 1000. As compared to the CRB insertion module shown in FIG. 8, both of which have selectors and function the same with the exception that FIG. 10 includes the queue reordering means 1002 for the physical storage location of the CRB to be processed as determined by the selector, right shifting each CRB following the CRB to be processed in the request queue by one CRB, then inserting a new CRB into the location of the next CRB of the CRB to be processed. This also reduces the procedure of interacting with the memory for storing and retrieving the state of the CRB. Preferably, the queue reordering means 1002 also updates the state of the two (2) state description bits 707 accordingly, such that the hardware accelerator knows how to process the state while processing the CRB. Preferably, the CRB insertion module 1000 can also include the lock module as shown in FIG. 8 and function the same. The CRB insertion module 1000 may be implemented with hardware logic and the design tool can automatically generate the logic after the function thereof is described by the hardware description language.

Since CAM is a hardware module, wiring from the respective data entries to CAM is digital data entry. The area of which will be relatively large. Therefore, the above embodiments may be further improved. FIG. 11 shows a structural diagram of a system 1100 for reordering the request queue of the hardware accelerator according to another embodiment of the invention. According to FIG. 11, the system of reordering the request queue of the hardware accelerator has added a mapping module 1105 for mapping the state pointer of the CRB in the request queue and the CRB requesting to join the request queue in the data entry having fewer digits and inputting the data entry into CAM. For example, the state pointer of the original CRB is a location in the memory and is a data entry of 64 bits. Wiring to CAM will be 64×8 and may be mapped by the mapping module into a data line of three (3) bits, such that wiring to CAM is only 3×8, thereby reducing chip area. The CRB insertion module in the system in which the mapping module is added may use any CRB insertion module described above.

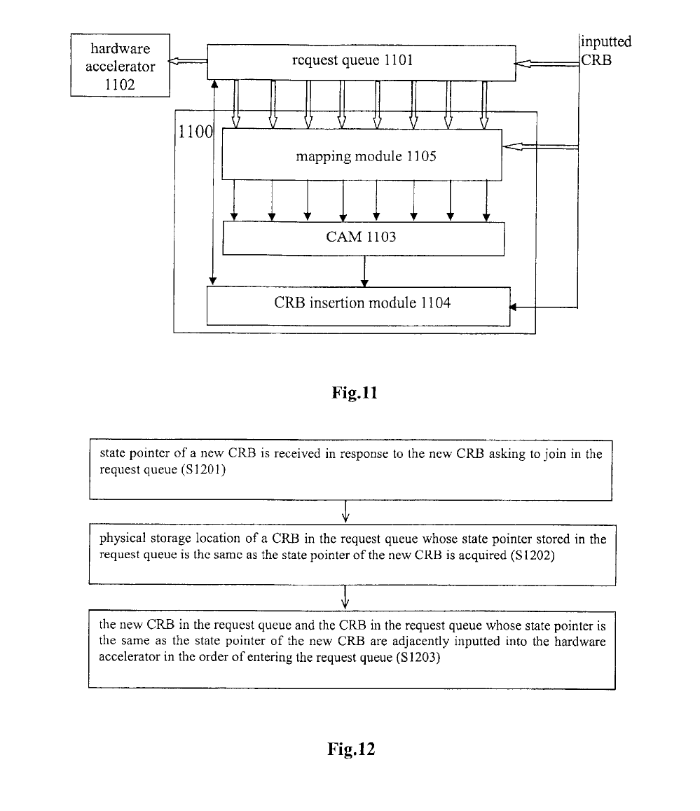

Using the same concept, the invention also discloses a method for reordering the request queue of the hardware accelerator; wherein, the request queue stores therein a plurality of CRBs to be input into the hardware accelerator. FIG. 12 shows a flowchart of a method for reordering the request queue of the hardware accelerator according to one embodiment of the invention. According to FIG. 12, in step S1201, the state pointer of a new CRB is received in response to the new CRB requesting to join the request queue. In step S1202, the physical storage location of a CRB in the request queue whose state pointer that is stored in the request queue and is the same as the state pointer of the new CRB is acquired. In step S1203, the new CRB in the request queue and the CRB in the request queue whose state pointer is the same as the state pointer of the new CRB are adjacently input into the hardware accelerator in the order they entered the request queue.

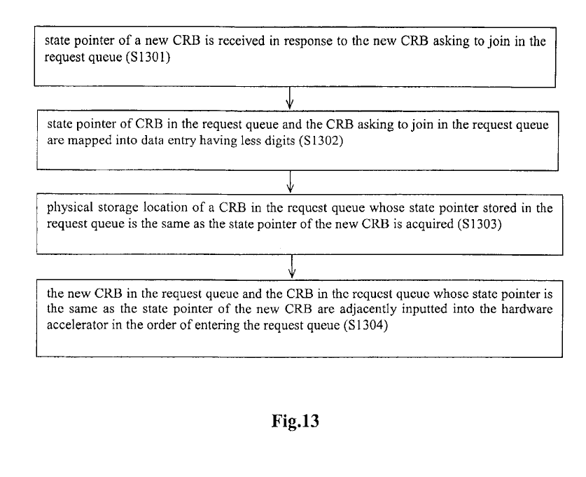

Preferably, FIG. 13 shows a preferred embodiment of the method shown in FIG. 12. In this embodiment, steps S1301, S1303, and S1304 corresponding to the steps shown in FIG. 12, further include S1302, which is after step S1301, in which the state pointer of the CRB in the request queue and the CRB asking to join in the request queue are mapped into data entry with less digits.

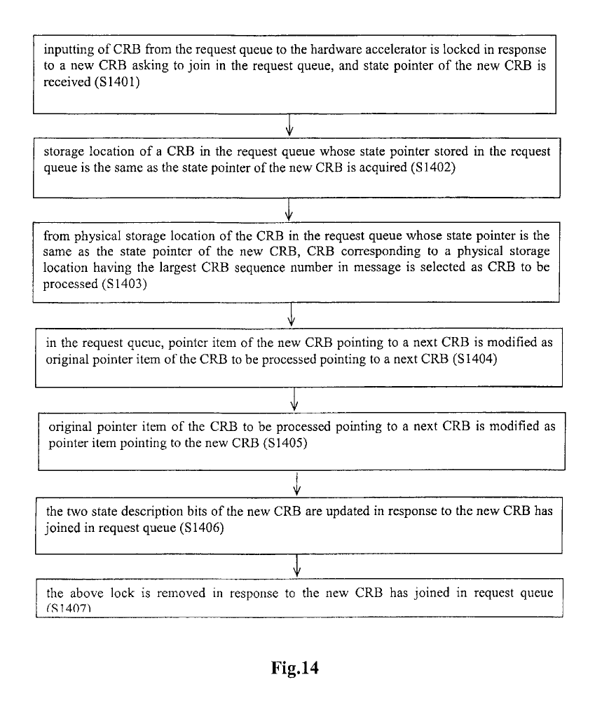

FIG. 14 shows another preferred embodiment of the method shown in FIG. 12. In this embodiment, the CRB also contains a pointer item for pointing to the location of a next CRB in the request queue to be input into the hardware accelerator. The CRB also contains the CRB sequence number in the message for specifying the CRB sequence of the CRB in all CRB messages describing that message. Preferably, the CRB also contains: two (2) state description bits in which one state description bit is used to indicate whether the state of the processed CRB is stored into memory; and the other state description hit is used to indicate whether processing of the CRB needs to retrieve the current state of the message previously stored in memory. According to FIG. 14, in step S1401, inputting the CRB from the request queue to the hardware accelerator is locked in response to a new CRB asking to join in the request queue. The state pointer of the new CRB is received. Step S1402, the storage location of a CRB in the request queue whose state pointer is stored in the request queue is the same as the state pointer of the new CRB is acquired. In step S1403, from the acquired physical storage location of the CRB in the request queue whose state pointer is the same as the state pointer of the new CRB, the CRB corresponding to a physical storage location having the largest CRB sequence number in the message is selected as the CRB to be processed. In step S1404, in the request queue, the pointer item of the new CRB pointing to a next CRB is modified as the original pointer item of the CRB to be processed and points to a next CRB. In step S1405, the original pointer item of the CRB to be processed points to a next CRB and is modified as the pointer item pointing to the new CRB. Preferably, in step S1406, the two (2) state description bits of the new CRB are updated in response to the new CRB having joined in the request queue. In step S1407, the above lock is removed in response to the new CRB having joined in the request queue.

Obviously, step S1302 of mapping the state pointer of the CRB in the request queue and the CRB asking to join in the request queue into data entry having less digits in FIG. 13 may also be added into the step of FIG. 14 and constitutes another preferred embodiment. In particular, it is added between steps S1401 and S1402.

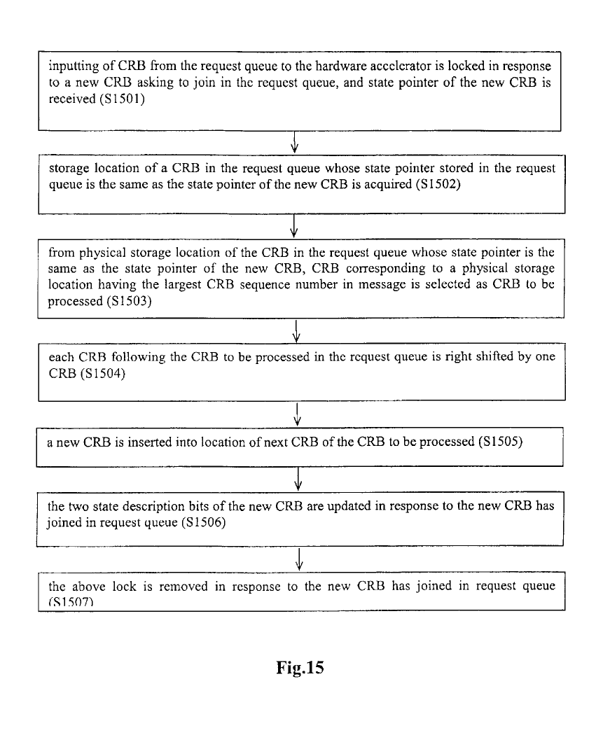

FIG. 15 shows yet another preferred embodiment of the method shown in FIG. 12. In this embodiment, the CRB contains the CRB sequence number in the message. Preferably, the CRB contains two (2) state description hits in which one state description bit is used to indicate whether the state of the processed CRB is stored in memory; the other state description bit is used to indicate whether processing of the CRB needs to retrieve the current state of the message previously stored in memory. According to FIG. 15, in step S1501, inputting of the CRB from the request queue to the hardware accelerator is locked in response to a new CRB asking to join in the request queue. The state pointer of the new CRB is received, step S1502. The storage location of a CRB in the request queue whose state pointer is stored in the request queue and is the same as the state pointer of the new CRB is acquired. In step S1503, from the physical storage location of the CRB in the request queue whose state pointer is the same as the state pointer of the new CRB, the CRB corresponding to a physical storage location having the largest CRB sequence number in the message is selected as the CRB to be processed. In step S1504, each CRB following the CRB to be processed in the request queue is right shifted by one CRB. In step S1505, a new CRB is inserted into the location of the next CRB of the CRB to be processed. Preferably, in step S1506, the two (2) state description bits of the new CRB are updated in response to the new CRB having joined in the request queue. In step S1507, the above lock is removed in response to the new CRB having joined in the request queue.

Obviously, step S1302 of mapping the state pointer of the CRB in the request queue and the CRB asking to join in the request queue into data entry having less digits in FIG. 13 may also be added into a step in FIG. 15 and constitutes yet another preferred embodiment. In particular, it may he added between steps S1501 and S1502.

Although exemplary embodiments of the invention have been described with reference to accompany drawings, it should be appreciated that the invention is not limited to these precise embodiments. Those skilled in the art can make various changes and modifications to these embodiments without departing from the scope and spirit of the invention. All these changes and modifications are intended to be included in the scope of the invention as defined by the appended claims.

1. A system for reordering a request queue for a hardware accelerator comprising:
a processor; and
a computer memory holding computer program instructions that when executed by the processor performs the method comprising:
storing a plurality of compressor request blocks (CRBs) to be input into the hardware accelerator in a request queue;
receiving a state pointer from a new CBR joining the request queue;
determining the physical location of an already stored CRB in said request queue, said already stored CRB having a state pointer that is the same as the state pointer of the new CRB; and
inputting the new CRB in the request queue so that said already stored CRB and the new CRB are adjacent to each other in the request queue in the order of entry of the stored CRB and the new CRB into the queue, wherein stored CRB and the new CRB are input to the hardware accelerator in said order.

2. The system of claim 1 wherein said performed method further includes mapping the state pointer of the already stored CRB and the state pointer of the new CRB wherein the entry data representing the new CRB has less digits before determining the physical location of a CRB.

3. The system of claim 2, wherein each CRB stored in the queue includes:
a pointer item pointing to the next CRB is the request queue to be input into the hardware accelerator, and
a message including the sequence number of said CRB within all CRBs in the message.

4. The system of claim 3, wherein said performed method inputs the new CRB in the request queue so that said already stored CRB and the new CRB are adjacent to each other in the request queue in the order of entry of the stored CRB and the new CRB into the queue, wherein stored CRB and the new CRB are input to the hardware accelerator in said order including:
selecting between the stored CRB and the new CRB, the one having the largest sequence number in said message to be processed, and
modifying said pointer item of the new CRB so as to point to said already stored CRB as the next CRB to be input.

5. The system of claim 4, wherein:
each CRB includes two (2) state description bits:
a first state description bit indicating whether the state of each processed CRB bit is stored in memory;
a second state description bit indicating whether processing of the CRB needs to retrieve the current state of said previously stored message; and
said performed method further includes updating the two (2) state description bits of a new CRB in response to said new CRB joining said request queue.

6. The system of claim 5, wherein the performed method further includes:
locking the input of the already stored CRB to said hardware accelerator in response to said new CRB joining said request queue; and
removing said lock upon the completion of the new CRB joining said queue.

7. The system of claim 3 wherein the new CRB includes a message including the sequence number of the new CRB within all CRBs in the message.

8. The system of claim 7 wherein said performed method of inputting the new CRB in the request queue so that said already stored CRB and the new CRB are adjacent to each other in the request queue in the order of entry of the stored CRB and the new CRB into the queue includes:
selecting between the stored CRB and the new CRB, the one having the largest sequence number in said message to be input into the hardware accelerator; and
right shifting by one each CRB in said request queue following the CRB being input; and
inserting a new CRB into the queue location of the next CRB being input to said hardware accelerator.

9. The system of claim 8, wherein:
each CRB includes two (2) state description bits:
a first state description bit indicating whether the state of each processed CRB hit is stored in memory;
a second state description bit indicating whether processing of the CRB needs to retrieve the current state of said previously stored message; and
said method further includes updating the two (2) state description bits of a new CRB in response to said new CRB joining said request queue.

10. The system of claim 9, wherein the performed method further includes:
locking the input of the already stored CRB to said hardware accelerator in response to said new CRB joining said request queue; and
removing said lock upon the completion of the new CRB joining said queue.

11. The system of claim 1 further including an integrated circuit chip including said processor, computer memory, request queue, CRBs and hardware accelerator.

12. A method for reordering a request queue for a hardware accelerator comprising:
storing a plurality of compressor request blocks (CRBs) to be input into the hardware accelerator in a request queue;
receiving a state pointer from a new CRB joining the request queue;
determining the physical location of an already stored CRB in said request queue, said already stored CRB having a state pointer that is the same as the state pointer of the new CRB; and
inputting the new CRB in the request queue so that said already stored CRB and the new CRB are adjacent to each other in the request queue in the order of entry of the stored CRB and the new CRB into the queue, wherein stored CRB and the new CRB are input to the hardware accelerator in said order.

13. The method of claim 12 further including mapping the state pointer of the already stored CRB and the state pointer of the new CRB wherein the entry data representing the new CRB has less digits before determining the physical location of a CRB.

14. The method of claim 13, wherein each CRB stored in the queue includes:
a pointer item pointing to the next CBR in the request queue to be input into the hardware accelerator, and
a message including the sequence number of said CRB within all CRBs in the message.

15. The method of claim 14, wherein said inputting of the new CRB in the request queue so that said already stored CRB and the new CRB are adjacent to each other in the request queue in the order of entry of the stored CRB and the new CRB into the queue, wherein stored CRB and the new CRB are input to the hardware accelerator in said order including:
selecting between the stored CRB and the new CRB, the one having the largest sequence number in said message to be processed, and
modifying said pointer item of the new CRB so as to point to said already stored CRB as the next CRB to be input.

16. The method of claim 15, wherein:
each CRB includes two (2) state description bits:
a first state description hit indicating whether the state of each processed CRB bit is stored in memory;
a second state description bit indicating whether processing of the CRB needs to retrieve the current state of said previously stored message; and
said method further includes updating the two (2) state description bits of a new CRB in response to said new CRB joining said request queue.

17. The method of claim 16 further including:
locking the input of the already stored CRB to said hardware accelerator in response to said new CRB joining said request queue; and
removing said lock upon the completion of the new CRB joining said queue.

18. The method of claim 14 wherein the new CRB includes a message including the sequence number of the new CRB within all CRBs in the message.

19. The method of claim 18 wherein said inputting of the new CRB in the request queue so that said already stored CRB and the new CRB are adjacent to each other in the request queue in the order of entry of the stored CRB and the new CRB into the queue includes:
selecting between the stored CRB and the new CRB, the one having the largest sequence number in said message to be input into the hardware accelerator; and
right shifting by one each CRB in said request queue following the CRB being input; and
inserting a new CRB into the queue location of the next CRB being input to said hardware accelerator.

20. The method of claim 19, wherein:
each CRB includes two (2) state description bits:
a first state description bit indicating whether the state of each processed CRB bit is stored in memory;
a second state description bit indicating whether processing of the CRB needs to retrieve the current state of said previously stored message; and
said method further includes updating the two (2) state description bits of a new CRB in response to said new CRB joining said request queue.

21. The method of claim 20 further including:
locking the input of the already stored CRB to said hardware accelerator in response to said new CRB joining said request queue; and
removing said lock upon the completion of the new CRB joining said queue.
